(19) United States
(12) Patent Application Publication
(10) Pub. No.: US 2026/0204556 A1
(43) Pub. Date: Jul. 16, 2026

(54) Positive Electrode Active Material, Positive Electrode Active Material Slurry, Positive Electrode, Lithium Ion Secondary Battery and Method for Preparing Positive Electrode Active Material

(71) Applicant: LG Energy Solution, Ltd., Seoul (KR)

(72) Inventor: Kuniko Chihara, Kanagawa (JP)

(73) Assignee: LG Energy Solution, Ltd., Seoul (KR)

(21) Appl. No.: 19/134,023

(22) PCT Filed: Jan. 3, 2024
(86) PCT No.: PCT/KR2024/000143

§ 371 Date: May 29, 2025

(30) Foreign Application Priority Data
Jan. 6, 2023 (JP) 2023-001342

(51) Int. Cl. H01M 4/525; H01M 4/02; H01M 4/04; H01M 10/0525

(52) U.S. Cl. CPC H01M 4/525; H01M 4/0404; H01M 10/0525; H01M 2004/028

(57) ABSTRACT

A positive electrode active material includes a mixture of lithium transition metal oxide particles and magnesium fluoride particles, wherein a 1s electron spectrum for fluorine observed by X-ray photoelectron spectroscopy analysis has a peak at from 685 eV to 687 eV. A positive electrode active material slurry, a positive electrode, and a lithium ion secondary battery having outstanding cycling characteristics and electrode resistance characteristics are also provided. Additionally, a method for preparing a positive electrode active material having outstanding cycling characteristics and electrode resistance characteristics is also provided.

### CROSS-REFERENCE TO RELATED APPLICATIONS

The present application is a national phase entry under 35 U.S.C. § 371 of International Application No. PCT/KR2024/000143 filed Jan. 3, 2024, which claims priority to Japanese Patent Application No. 2023-001342 filed on Jan. 6, 2023, the disclosures of which are incorporated herein by reference.

### TECHNICAL FIELD

Aspects of the present disclosure relate to a positive electrode active material, a positive electrode active material slurry, a positive electrode, a lithium ion secondary battery, and a method for preparing a positive electrode active material.

### BACKGROUND

With the technology development of mobile devices, there is a growing demand for secondary batteries as an energy source. Among secondary batteries, lithium ion secondary batteries having high energy density and voltage, long cycle life, and low self-discharge rate are commercialized and widely used. Currently, many studies are being conducted to increase the capacity of lithium ion secondary batteries.

In the trend towards higher capacity of lithium ion secondary batteries, in order to improve stability (cycling characteristics) of batteries, for example, a thin film of fluorine-based material formed on the surface of an electrode active material is known (see Patent Literature 1).
Patent Literature 1: Japanese Patent Publication No. 2018-063835

### Technical Problem

However, when a thin film is formed on a surface of an electrode active material, sufficient electrode resistance characteristics may not be obtained. That is, the electrode resistance characteristics may degrade (i.e., the electrode resistance may increase) because the thin film has low conductivity. Accordingly, an electrode active material having both outstanding cycling characteristics and electrode resistance characteristics is required.

The present disclosure is directed to providing a positive electrode active material, a positive electrode active material slurry, a positive electrode, and a lithium ion secondary battery having outstanding cycling characteristics and electrode resistance characteristics. Further, a method of preparing a positive electrode active material having outstanding cycling characteristics and electrode resistance characteristics is also provided.

### Technical Solution

The present disclosure may include the following aspects.

[1] A positive electrode active material including a mixture of lithium transition metal oxide particles and magnesium fluoride particles, wherein a 1s electron spectrum for fluorine observed by X-ray photoelectron spectroscopy analysis has a peak at from 685 eV to 687 eV.
[2] The positive electrode active material defined in [1], wherein the lithium transition metal oxide particles do not have a thin film of the magnesium fluoride.
[3] The positive electrode active material defined in [1] or [2], wherein the magnesium fluoride particles are not sintered with the lithium transition metal oxide particles.
[4] The positive electrode active material defined in any one of [1] to [3], wherein the magnesium fluoride particles are included in an amount ranging from 0.02 parts by mass to 1 part by mass based on 100 parts by mass of the lithium transition metal oxide particles.
[5] The positive electrode active material defined in any one of [1] to [4], wherein the lithium transition metal oxide includes nickel.
[6] The positive electrode active material defined in any one of [1] to [5], wherein the lithium transition metal oxide is represented by LiₐNiₓM_{y}O₂ (0<a≤1.05, x+y=1, 0.4≤x≤1, M is at least one type of metal other than Ni).
[7] The positive electrode active material defined in any one of [1] to [6], wherein when comparing a first lithium ion secondary battery manufactured using a positive electrode including a positive electrode active material layer including 96.5 parts by mass of the positive electrode active material, 1.5 parts by mass of carbon black and 2 parts by mass of polyvinylidene fluoride on a current collector and a negative electrode including graphite with a second lithium ion secondary battery manufactured in a same condition as the first lithium ion secondary battery except that a positive electrode active material obtained by sintering the positive electrode active material at 350° C. for 5 hours was used instead of the positive electrode active material, the first lithium ion secondary battery has a larger value obtained by dividing a discharge capacity in a 100th charge/discharge cycle by a discharge capacity in a first charge/discharge cycle than the second lithium ion secondary battery.
[8] A positive electrode active material slurry including the positive electrode active material defined in any one of [1] to [7].
[9] A positive electrode comprising a current collector, and a positive electrode active material layer including the positive electrode active material defined in any one of [1] to [7] on the current collector.
[10] A lithium ion secondary battery comprising the positive electrode defined in [9].
[11] A method for preparing a positive electrode active material, comprising mixing lithium transition metal oxide particles with magnesium fluoride particles, wherein a 1s electron spectrum for fluorine observed by X-ray photoelectron spectroscopy analysis of the positive electrode active material has a peak at from 685 eV to 687 eV.
[12] The method for preparing the positive electrode active material defined in [11], wherein the method does not include sintering a mixture of the lithium transition metal oxide particles and the magnesium fluoride particles.
[13] The method for preparing the positive electrode active material defined in [11] or [12], wherein the positive electrode active material includes the mixture of the lithium transition metal oxide particles and the magnesium fluoride particles.

### Advantageous Effects

According to the present disclosure, it may be possible to provide a positive electrode active material, a positive electrode active material slurry, a positive electrode, and a lithium ion secondary battery having outstanding cycling characteristics and electrode resistance characteristics. A method for preparing a positive electrode active material having outstanding cycling characteristics and electrode resistance characteristics is also provided.

### BRIEF DESCRIPTION OF THE DRAWINGS

FIG. 1 shows is electron X-ray photoelectron spectroscopy (XPS) spectra for fluorine of positive electrode active materials according to Example 1-1, Comparative Example 1-1, and Comparative Example 2-1.

FIG. 2 shows 2p electron XPS spectra for magnesium of positive electrode active materials according to Example 1-1, Comparative Example 1-1, and Comparative Example 2-1.

FIG. 3 shows changes in capacity retention over first to 300th charge and discharge in monocell batteries according to Examples and Comparative Examples.

FIG. 4 shows changes in direct current resistance over first to 300th charge and discharge in monocell batteries according to Example 1-1, Comparative Example 1-1, and Comparative Example 2-1.

### DETAILED DESCRIPTION

Hereinafter, a positive electrode active material, a positive electrode active material slurry, a positive electrode, a lithium ion secondary battery, and a method for preparing a positive electrode active material according to aspects will be described. Meanwhile, the following aspects represent aspects of the present disclosure and are not intended to limit the present disclosure, and may be arbitrarily changed within the scope of technical aspect of the present disclosure. Each element and each feature of the aspects may be arbitrarily combined. When a plurality of numerical ranges is listed below, upper and lower limits of each numerical range may be arbitrarily combined.

The problem with electrode resistance characteristics that may arise from higher capacity of lithium ion secondary batteries will be described, taking a lithium ion secondary battery using lithium transition metal oxide having high nickel content as a positive electrode material as an example.

As the positive electrode material of the lithium ion secondary battery, in a lithium nickel cobalt manganese three-component positive electrode active material such as LiₐNiₓCo_{y}Mn_{z}O₂, it is known that high nickel content in the composition contributes to high capacity. In practice, higher capacity of the lithium ion secondary battery is always required in the market, and many efforts are devoted to developing Ni rich positive electrode active materials having high capacity per unit mass in an operating voltage range of between 3.0V and 4.2V as an alternative to LiCoO₂. However, in lithium nickel cobalt manganese three-component positive electrode active materials, problems occur, for example, gas generation at high temperature or low stability in a charged state with increasing Ni content makes their use in battery applications challenging.

To solve this problem, a method that forms an insulating thin film on the surface of positive electrode active material particles is suggested to improve stability during charging. Meanwhile, there are not many reports about the means for suppressing gas generation, but Patent Literature 1 discloses forming a fluoride-based thin film on the surface of Li-excess layered rocksalt-type positive electrode active material. However, the surface of the Ni rich positive electrode material is easily influenced by ionic conductivity or electron conduction. For this reason, the Ni rich positive electrode active material is greatly influenced by the increase in resistance component resulting from the thin film formation.

The inventors found that lithium ion secondary batteries having outstanding cycling characteristics and electrode resistance characteristics are obtained by using the positive electrode active material including a mixture of lithium transition metal oxide particles and magnesium fluoride particles, and completed the present disclosure.

### [Positive Electrode Active Material]

According to an aspect of the present disclosure, provided is a positive electrode active material including a mixture of lithium transition metal oxide particles and magnesium fluoride particles, wherein a 1s electron spectrum for fluorine observed by X-ray photoelectron spectroscopy analysis has a peak at from 685 eV to 687 eV. Preferably, the positive electrode active material is a positive electrode active material for a lithium ion secondary battery.

The ‘lithium transition metal oxide’ as used herein refers to a compound including lithium and a transition metal, and having transition metal-oxygen bonds, and includes those including a metal, such as aluminum, or a nonmetal other than oxygen, such as iodine. The ‘mixture’ as used herein refers to two or more materials simply mixed together, wherein the majority of the two or more materials (for example, 50 mass % or more) does not change in chemical state by chemical reaction between the two or more materials or sintering.

The positive electrode active material includes a lithium transition metal oxide, capable of intercalating and deintercalating lithium, and magnesium fluoride. The positive electrode active material may be a physical mixture of lithium transition metal oxide particles and magnesium fluoride particles. Meanwhile, the positive electrode active material may include lithium transition metal oxide and any material other than magnesium fluoride. For example, the positive electrode active material may or may not include a fluorine-containing material other than magnesium fluoride, such as lithium fluoride or aluminum fluoride.

### (Lithium Transition Metal Oxide)

The lithium transition metal oxide particles may exist as primary particles or agglomerates of primary particles. The particle size may range from, for example, 10 nm to 100 μm, 0.1 μm to 10 μm, but is not limited thereto.

The lithium transition metal oxide includes, for example, nickel. Preferably, the lithium transition metal oxide may be a nickel-rich lithium transition metal oxide. Here, ‘nickel-rich’ refers to 50 mol % or more of nickel based on the total amount of transition metal. As described above, the nickel-rich lithium transition metal oxide including, for example, 50 mol % or more of nickel requires improved stability (i.e., cycling characteristics) during charging. For this reason, improvement in cycling characteristics using the positive electrode active material according to this aspect may contribute to high capacity and improved cycling characteristics of the lithium ion secondary battery. For example, the lithium transition metal oxide may include 60 mol % or more, 70 mol % or more, 80 mol % or more, or 90 mol % or more of nickel based on the total amount of transition metal. For example, the lithium transition metal oxide may be represented by LiₐNiₓM_{y}O₂ (0<a≤1.05, x+y=1, 0.4≤x≤1, M is at least one type of metal other than Ni).

Examples of the lithium transition metal oxide may include lithium-manganese oxide (for example, LiMnO₂, LiMnO₃, LiMn₂O₃, LiMn₂O₄); lithium-cobalt oxide (for example, LiCoO₂); lithium-nickel oxide (for example, LiNiO₂); lithium-copper oxide (for example, Li₂CuO₂); lithium-vanadium oxide (for example, LiV₃O₈); lithium-nickel-manganese oxide (for example, LiNi_{1-z}Mn_{z}O₂ (0<z<1), LiMn_{2-z}Ni_{z}O₄ (0<z<2)); lithium-nickel-cobalt oxide (for example, LiNi_{1-y}Co_{y}O₂ (0<y<1)); lithium-manganese-cobalt oxide (for example, LiCo_{1-z}Mn_{z}O₂ (0<z<1), LiMn_{2-y}Co_{y}O₄ (0<y<2)); lithium-nickel-manganese-cobalt oxide (for example, Li(NiₓCo_{y}Mn_{z})O₂ (0<x<1, 0<y<1, 0<z<1, x+y+z=1), Li(NiₓCo_{y}Mn_{z})O₄ (0<x<2, 0<y<2, 0<z<2, x+y+z=2)); lithium-nickel-cobalt-metal (M) oxide (for example, Li(NiₓCo_{y}Mn_{z}M_{w})O₂ (M is selected from the group consisting of Al, Fe, V, Cr, Ti, Ta, Mg and Mo, 0<x<1, 0<y<1, 0<z<1, 0<w<1, x+y+z+w=1)); Li-excess solid solution positive electrode (for example, pLi₂MnO₃-(1−p)Li(NiₓCo_{y}Mn_{z})O₂ (0<x<1, 0<y<1, 0<z<1, x+y+z=1, 0<p<1); compounds with substitution of other one or two or more metals for transition metal in these compounds. The positive electrode active material layer may include any one of them or a compound of two or more of them, but is not limited thereto.

In particular, examples of the nickel-rich lithium transition metal oxide that is effective in increasing the capacity of the battery may include LiₐNiO₂ (0.5≤a≤1.5); Liₐ(NiₓCo_{y}Mn_{z})O₂ (0.5≤a≤1.5, 0.5≤x<1, 0<y<0.5, 0<z<0.5, x+y+z=1); Liₐ(NiₓCo_{y}Mn_{z})O₂ (0.7≤x<1, 0<y<0.3, 0<z<0.3, x+y+z=1); Liₐ(NiₓCo_{y}Mn_{z})O₂ (0.8≤x<1, 0<y<0.2, 0<z<0.2, x+y+z=1); Liₐ(NiₓCo_{y}Mn_{z})O₂ (0.9≤x<1, 0<y<0.1, 0<z<0.1, x+y+z=1); LiₐNi_{1-y}Co_{y}O₂ (0.5≤a≤1.5, 0<y≤0.5); LiₐNi_{1-z}Mn_{z}O₂ (0.5≤a≤1.5, 0<z≤0.5); Liₐ(NiₓCo_{y}Mn_{z})O₄ (0.5≤a≤1.5, 1≤x<2, 0<y<1, 0<z<1, x+y+z=2); Liₐ(NiₓCo_{y}M_{w})O₂(M is at least one selected from the group consisting of Al, Fe, V, Cr, Ti, Ta, Mg, Mo, Zr, Zn, Ga and In, 0.5≤a≤1.5, 0.5≤x<1, 0<y<0.5, 0<w<0.5, x+y+w=1); Liₐ(NiₓCo_{y}Mn_{z}M_{w})O₂ (M is at least one selected from the group consisting of Al, Fe, V, Cr, Ti, Ta, Mg, Mo, Zr, Zn, Ga and In, 0.5≤a≤1.5, 0.5≤x<1, 0<y<0.5, 0<z<0.5, 0<w<0.5, x+y+z+w=1); compounds with substitution of at least one other type of metal (for example, at least one of Al, Fe, V, Cr, Ti, Ta, Mg, Mo, Zr, Zn, Ga or In) for transition metal atoms in these compounds in at least part; compounds with partial substitution of at least one other type nonmetal (for example, at least one of P, F, S or N) for oxygen atoms in these compounds. Preferably, the lithium transition metal oxide is represented by LiₐNiₓM_{y}O₂ (M is at least one metal other than Ni, for example, at least one selected from the group consisting of Al, Fe, Co, Mn, V, Cr, Ti, Ta, Mg, Mo, Zr, Zn, Ga and In, 0<a≤1.05, x+y=1), wherein a value of x may be, for example, 0.3 or more, 0.4 or more, 0.5 or more, 0.6 or more, 0.7 or more, 0.8 or more or 0.9 or more, and for example 1 or less, 0.9 or less, 0.8 or less, 0.7 or less, 0.6 or less or 0.5 or less. The positive electrode active material may include at least one of them, but is not limited thereto. Additionally, even in the same particle, there may be a distribution in substitution concentration between inside and surface. Additionally, the particle surface may have coating. For example, the surface may be coated with metal oxide, lithium transition metal oxide or polymer, but is not limited thereto.

In particular, in terms of improvement in capacity characteristics and stability of the battery, LiₐNiO₂, Liₐ(Ni_{0.5}Mn_{y}Co_{z})O₂(y+z=0.5), Liₐ(Ni_{0.6}Mn_{y}Co_{z})O₂ (y+z=0.4), Liₐ(Ni_{0.7}Mn_{y}Co_{z})O₂(y+z=0.3), Liₐ(Ni_{0.8}Mn_{y}Co_{z})O₂(y+z=0.2), Liₐ(Ni_{0.8}Co_{y}Mn_{z}Al_{w})O₂(y+z+w=0.2), Liₐ(Ni_{0.85}Co_{y}Mn_{z})O₂(y+z=0.15), Liₐ(Ni_{0.85}Co_{y}Mn_{z}Al_{w})O₂(y+z+w=0.15), Liₐ(Ni_{0.9}Co_{y}Mn_{z})O₂(y+z=0.1), Liₐ(Ni_{0.9}Co_{y}Mn_{z}Al_{q})O₂(y+z+w=0.1), Liₐ(Ni_{0.9}Co_{y}Mn_{z})O₂(y+z=0.1) or Liₐ(Ni_{0.95}Co_{y}Mn_{z}Al)O₂(y+z+w=0.05) is preferred. Here, a value of a may be, for example, 0.5≤a≤1.5, and preferably 1.0≤a≤1.5.

More specifically, LiNiO₂, Li(Ni_{0.5}Mn_{0.3}Co_{0.2})O₂, Li(Ni_{0.6}Mn_{0.2}Co_{0.2})O₂, Li(Ni_{0.7}Mn_{0.15}Co_{0.15})O₂, Li(Ni_{0.8}Mn_{0.1}Co_{0.1})O₂, Li(Ni_{0.8}Co_{0.15}Al_{0.05})O₂, Li(Ni_{0.8}Co_{0.1}Mn_{0.05}Al_{0.05})O₂, Li(Ni_{0.85}Co_{0.10}Mn_{0.05})O₂, Li(Ni_{0.85}Co_{0.10}Mn_{0.03}Al_{0.02})O₂, Li(Ni_{0.9}Co_{0.05}Mn_{0.05})O₂, Li(Ni_{0.9}Co_{0.05}Al_{0.05})O₂, Li(Ni_{0.95}Co_{0.03}Mn_{0.02})O₂ or Li(Ni_{0.95}Co_{0.03}Al_{0.02})O₂ is preferred.

### (Magnesium Fluoride)

In at least a part of the positive electrode active material, the magnesium fluoride exists in the form of particles. Preferably, the magnesium fluoride is in the form of particles that are independent from the lithium transition metal oxide particles, but not a thin film that covers the lithium transition metal oxide particles. For example, the magnesium fluoride particles are in contact with the surface of the lithium transition metal oxide particles. That is, the surface of the lithium transition metal oxide particles is exposed and come into contact with the magnesium fluoride particles that are independent from the lithium transition metal oxide particles. Preferably, the thin film of magnesium fluoride is not formed on the surface of the lithium transition metal oxide particles to suppress the increase in surface resistance of the lithium transition metal oxide particles due to the thin film. Preferably, there is no chemical bond between the lithium transition metal oxide particles and the magnesium fluoride particles. Preferably, the magnesium fluoride particles are not sintered with the lithium transition metal oxide particles. Here, ‘sinter’ refers to heating at least one material to lower temperature than the melting point of the material in a state that the particles of the material are in contact with each other, in order to hold the adjacent particles together.

The magnesium fluoride particles may exist as primary particles, or secondary particles, i.e., agglomerates of primary particles. The particle size may range from, for example, 1 nm to 100 μm, 10 nm to 10 μm, 100 nm to 1 μm, but is not limited thereto.

In the positive electrode active material, the amount of the magnesium fluoride ranges from, for example, 0.02 parts to 1 part by mass based on 100 parts by mass of the lithium transition metal oxide. When the amount of the magnesium fluoride is equal to or more than 0.02 parts by mass, improved cycling characteristics by the magnesium fluoride are expected. When the amount of the magnesium fluoride is equal to or less than 1 part by mass, the increase in electrode resistance will be suppressed by excess magnesium fluoride covering the surface of the lithium transition metal oxide particles. The amount of the magnesium fluoride preferably ranges from 0.03 parts to 0.5 parts by mass, more preferably 0.04 parts to 0.3 parts by mass, and more preferably 0.05 parts by mass to 0.2 parts by mass, based on 100 parts by mass of the lithium transition metal oxide.

### (X-Ray Photoelectron Spectroscopy (XPS) Spectrum of Positive Electrode Active Material)

XPS analysis is the technique that detects photoelectrons emitted from the sample surface using an analyzer by soft X-ray irradiation onto the surface in an ultrahigh vacuum. From the fact that the length (the mean free path) of travel of a photoelectron in the material is a few nm, the detection depth of the analysis method is a few nm. The element information of surface is obtained from the binding energy value of a bound electron in the material, and information associated with valence or coupled state is obtained from the energy shift of each peak. The ratio of elements (composition) may be quantitatively evaluated from the peak area ratio.

The spectrum observed by X-ray photoelectron spectroscopy analysis (XPS) of the positive electrode active material has a peak derived from Fis electron of fluorine. When charge correction is performed with the energy of —(CH2)n- derived C1s peak top of 284.6 eV, the F1s electron spectrum for fluorine has the peak at from 685 eV to 687 eV. The peak position is preferably from 685.2 eV to 686 eV, and more preferably from 685.3 eV to 685.7 eV. This peak is derived from is electron of fluoride ions in magnesium fluoride. Here, the ‘peak position’ refers to maximum peak position (energy).

The spectrum observed by X-ray photoelectron spectroscopy analysis (XPS) of the positive electrode active material has a peak derived from 2p electron of magnesium. When charge correction is performed with the energy of —(CH2)n- derived C1s peak top of 284.6 eV, the 2p electron spectrum for magnesium has the peak at from 50 eV to 52 eV. The peak position preferably ranges from 50.5 eV to 51.5 eV, and more preferably 50.8 eV to 51.2 eV or less. This peak is derived from 2p electron of magnesium ions in magnesium fluoride.

### (Effect of Magnesium Fluoride)

As described in the following aspect, in cases where magnesium fluoride is added, compared to cases where no magnesium fluoride is added, it was confirmed that there was a tendency to suppress capacity fading and electrode resistance rise over repeated charge and discharge. Here, the capacity fading suppression refers to improvement in cycling characteristics, and the electrode resistance rise suppression refers to improvement in electrode resistance characteristics.

Additionally, when magnesium fluoride is added, in cases where sintering is not performed, compared to cases where sintering is performed, it was confirmed that there was a tendency to suppress capacity fading and electrode resistance rise over repeated charge and discharge. For example, when comparing a first lithium ion secondary battery manufactured from the above-described positive electrode active material according to the manufacturing method described in Example 1-1 as described below with a second lithium ion secondary battery manufactured by the manufacturing method described in Comparative Example 2-1 as described below (i.e., the method using a positive electrode active material obtained by sintering the above-described positive electrode active material at 350° C. for 5 hours, instead of the above-described positive electrode active material), the first lithium ion secondary battery has a larger value obtained by dividing the discharge capacity in n-th (for example, n=100) charge/discharge cycle by the discharge capacity in the first charge/discharge cycle than the second lithium ion secondary battery. Additionally, the first lithium ion secondary battery has a smaller value obtained by dividing direct current resistance in n-th (for example, n=100) charge/discharge cycle by direct current resistance in the first charge/discharge cycle than the second lithium ion secondary battery. More specifically, for example, when comparing the first lithium ion secondary battery manufactured using a positive electrode having the positive electrode active material layer including 96.5 parts by mass of the above-described positive electrode active material, 1.5 parts by mass of carbon black and 2 parts by mass of polyvinylidene fluoride on a current collector, and a negative electrode including graphite with the second lithium ion secondary battery manufactured in the same condition as the first lithium ion secondary battery except that the positive electrode active material obtained by sintering the positive electrode active material at 350° C. for 5 hours was used instead of the above-described positive electrode active material, the first lithium ion secondary battery has a larger value obtained by dividing the discharge capacity in the 100th charge/discharge cycle by the discharge capacity in the first charge/discharge cycle than the second lithium ion secondary battery. Additionally, the first lithium ion secondary battery has a smaller value obtained by dividing direct current resistance in the 100th charge/discharge cycle by direct current resistance in the first charge/discharge cycle than the second lithium ion secondary battery.

Although it is not intended to constrain the present disclosure by theory, it is thought that the following mechanism may be one of the causes of this tendency. Regarding the cycling characteristics, there is a likelihood that at least part of the improvements stemming from the addition of magnesium fluoride may disappear by decomposition of the magnesium fluoride by sintering, or reaction with the lithium transition metal oxide or the components in air. Regarding the electrode resistance characteristics, when the magnesium fluoride-derived thin film is formed on at least part of the surface of the lithium transition metal oxide particles by sintering, there is a likelihood that the surface resistance the lithium transition metal oxide particles may increase, compared to non-sintering. Additionally, when sintering is performed, Li residue such as lithium hydroxide present on the surface of the lithium transition metal oxide particles is changed to the resistance component such as lithium carbonate by sintering, which may adversely affect the characteristics, compared to non-sintering. Additionally, when the sintering process is not performed, side reaction in the sintering does not occur, and the cost does not increase.

### [Method for Preparing Positive Electrode Active Material]

According to an aspect of the present disclosure, there is provided a method for preparing a positive electrode active material, including the step of mixing lithium transition metal oxide particles with magnesium fluoride particles (a mixing step), wherein a 1s electron spectrum for fluorine observed by X-ray photoelectron spectroscopy analysis of the positive electrode active material has a peak at from 685 eV to 687 eV. The obtained positive electrode active material includes a mixture of lithium transition metal oxide particles and magnesium fluoride particles.

In the mixing step, the mixture including at least one type of lithium transition metal oxide and magnesium fluoride is prepared. For example, in the mixing process, the lithium transition metal oxide and the magnesium fluoride may be all mixed in solid state. For example, when the lithium transition metal oxide in powder state is mixed with the magnesium fluoride in powder state, the mixture in powder state is obtained. When the raw materials are mixed in solid state, the mixing process may be performed in a straightforward and convenient manner, and thus, it is possible to reduce the cost, and it is suitable for mass production. The mixing method is not limited to a particular one, and may include any existing method. Examples of the mixing method may include hand-operated mixing, a mortar (manual or automatic), a ball mill, a planetary mill, a vibration mill, a rotor mill, a hammer mill, a dispermill, a mixer, a homogenizer. The mixing step may be performed in air, and may be performed in any other atmosphere, for example, an inert atmosphere. The lithium transition metal oxide and any material other than the magnesium fluoride may be added. For example, any fluorine-containing material other than magnesium fluoride such as lithium fluoride or aluminum fluoride may be added, or may not be added.

The amount of the lithium transition metal oxide added in the mixing process ranges from, for example, 85 parts to 99.98 parts by mass, preferably 90 parts by mass to 99.9 parts by mass, and more preferably 95 parts by mass to 99.5 parts by mass, when the total mass of the mixture is 100 parts by mass.

The amount of the magnesium fluoride added ranges from, for example, 0.02 parts by mass to 1 part by mass, preferably 0.03 parts by mass to 0.5 parts by mass, more preferably 0.04 parts by mass to 0.3 parts by mass, and more preferably 0.05 parts by mass to 0.2 parts by mass.

Preferably, the method does not include the step of sintering the mixture of the lithium transition metal oxide particles and the magnesium fluoride particles. For example, the method does not include the step of heating the mixture of the lithium transition metal oxide particles and the magnesium fluoride particles at or above a predetermined temperature. For example, the predetermined temperature is lower than the temperature at which the sintering of the lithium transition metal oxide particles or the remaining elements on the surface, such as lithium hydroxide LiOH or lithium carbonate Li₂O₃, and the magnesium fluoride particles takes place. For example, the predetermined temperature is 150° C. or 200° C.

### [Positive Electrode Material]

According to an aspect of the present disclosure, there is a positive electrode material including the above-described positive electrode active material. Preferably, the positive electrode material is a positive electrode material for a lithium ion secondary battery. The positive electrode material includes, for example, the above-described positive electrode active material, optionally a conductive material, and optionally a binder. For example, the positive electrode material may be provided as a mixture powder including powder of the above-described positive electrode active material and powder of the conductive material, and may be provided as high viscosity composition in which the mixture powder is mixed with the binder.

The amount of the positive electrode active material included in the positive electrode material may range from 80 mass % to 99.5 mass % based on the total mass of the positive electrode material. The amount of the positive electrode active material may preferably range from 85 mass % to 98.5 mass %. When the amount of the positive electrode active material is within the aforementioned range, it may be possible to achieve outstanding capacity characteristics. In contrast, when the amount of the positive electrode active material is less than the aforementioned range, the coating amount and the thickness of the positive electrode increases, and thus, the positive electrode fails to achieve sufficient volumetric energy density. Further, when the amount of the positive electrode active material is more than the aforementioned range, the binder and the conductive material are insufficient, resulting in low conductivity and adhesion strength of the electrode and poor battery performance.

### (Conductive Material)

The conductive material may include any electrically conductive material that does not cause a chemical change without limitation. Examples of the conductive material may include any one of carbon-based materials such as artificial graphite, natural graphite, carbon black, acetylene black, Ketjen black, Denka black, thermal black, channel black, furnace black, lamp black, carbon nanotubes or carbon fibers; metal powder or metal fibers of aluminum, tin, bismuth, silicon, antimony, nickel, copper, titanium, vanadium, chrome, manganese, iron, cobalt, zinc, molybdenum, tungsten, silver, gold, lanthanum, ruthenium, platinum or iridium; conductive whiskers of zinc oxide or potassium titanate; conductive metal oxide such as titanium oxide; conductive polymer such as polyaniline, polythiophene, polyacetylene, polypyrrole or polyphenylene derivatives, or a mixture thereof, but is not limited thereto. Preferably, the positive electrode material includes at least one of carbon black or carbon nanotubes as the conductive material. In particular, as demonstrated in the following aspect, carbon nanotubes contribute to significant improvement in cycling characteristics and electrode resistance characteristics of the battery.

The amount of the conductive material may range from 0.1 mass % to 30 mass % based on the total mass of the positive electrode material. The amount of the conductive material may preferably range from 0.5 mass % to 15 mass %, and more preferably 0.5 mass % to 5 mass %. When the amount of the conductive material satisfies the aforementioned range, it may be possible to ensure sufficient conductivity, and the amount of the positive electrode active material does not reduce, thereby ensuring battery capacity.

### (Binder)

The binder is added as the component that promotes the bonding between the active material and the conductive material or the bonding to the current collector. Examples of the binder may include any one of polyvinylidene fluoride (PVDF), polyvinyl alcohol (PVA), polyacrylonitrile, carboxymethyl cellulose (CMC), starch, hydroxypropyl cellulose, regenerated cellulose, polyvinyl pyrrolidone, tetrafluoro ethylene, polyethylene, polypropylene, ethylene-propylene-diene polymer (EPDM), sulfonated EPDM, styrene butadiene rubber (SBR), fluoro rubber, their copolymers or a mixture thereof, but is not limited thereto.

The amount of the binder may range from 0.1 mass % to 30 mass % based on the total mass of the positive electrode material. The amount of the binder may preferably range from 0.5 mass % to 15 mass %, and more preferably 0.5 mass % to 5 mass %. When the amount of the binder polymer satisfies the aforementioned range, it may be possible to prevent the decrease in capacity characteristics of the battery and ensure sufficient adhesion strength in the electrode.

### [Method for Preparing Positive Electrode Material]

The positive electrode material may be obtained by adding the conductive material and the binder to the above-described positive electrode active material and mixing together. Optionally, any other additive may be added.

### [Positive Electrode Active Material Slurry]

According to an aspect of the present disclosure, there is provided a positive electrode active material slurry including the above-described positive electrode active material. Preferably, the positive electrode active material slurry is a positive electrode active material slurry for a lithium ion secondary battery. The positive electrode active material slurry includes, for example, the positive electrode active material, the conductive material, the binder, and a solvent. The positive electrode active material slurry may be coated on the current collector, followed by volatilization or evaporation of the solvent to form a positive electrode active material layer on the current collector. The amounts of the positive electrode active material, the conductive material, and the binder in the positive electrode active material layer are the same as the foregoing description of the positive electrode material.

### (Solvent)

The solvent used in the positive electrode active material slurry may include those commonly used to manufacture the positive electrode without limitation. Examples of the solvent may include any one of amine-based solvents such as N,N-dimethyl amino propyl amine, diethylene triamine or N,N-dimethyl formamide (DMF), ether-based solvents such as tetrahydrofuran, ketone-based solvents such as methyl ethyl ketone, ester-based solvents such as methyl acetate, amide-based solvents such as dimethylacetamide or 1-methyl-2-pyrrolidone (NMP), dimethylsulfoxide (DMSO) and water or a mixture thereof, but is not limited thereto.

The amount of the solvent may be such that the viscosity is enough to dissolve or disperse the positive electrode active material, the conductive material and the binder and ensure high thickness uniformity when coating on the positive electrode current collector, taking into account the coating thickness of the slurry or the manufacturing yield.

### [Method for Preparing Positive Electrode Active Material Slurry]

The positive electrode active material slurry is obtained by adding the conductive material, the binder, and the solvent to the above-described positive electrode active material, and mixing together. Optionally, any other additive such as a dispersing agent or a thickening agent may be added.

### [Positive Electrode]

According to an aspect of the present disclosure, there is provided a positive electrode including a current collector and a positive electrode active material layer including the above-described positive electrode active material on the current collector. That is, the positive electrode includes the positive electrode current collector and the positive electrode active material layer on one or two surfaces of the positive electrode current collector. The positive electrode active material layer may be formed on all or part of the surface of the positive electrode current collector. For example, the positive electrode is a positive electrode for a lithium ion secondary battery including an electrolyte solution.

### (Positive Electrode Current Collector)

The positive electrode current collector used in the positive electrode may include those having electrical and chemical stability and conductivity without limitation. For example, the positive electrode current collector may include any one of stainless steel; aluminum; nickel; titanium; or an alloy thereof, or a mixture thereof. Additionally, the positive electrode current collector may include sintered carbon, or aluminum or stainless steel treated with carbon, nickel, titanium or silver on the surface.

The positive electrode current collector may have a thickness ranging from 3 μm to 500 μm. The positive electrode current collector may have microtexture on the surface to increase the adhesion strength with the positive electrode active material. The positive electrode current collector may come in various forms, for example, film, sheet, foil, net, porous body, foam or nonwoven.

### (Positive Electrode Active Material Layer)

The positive electrode active material layer includes the above-described positive electrode active material, the conductive material, and the binder. The positive electrode active material layer may have a thickness ranging from, for example, 1 nm to 100 μm, 10 nm to 10 μm, or 100 nm to 1 μm. The positive electrode active material layer may be directly formed on the positive electrode current collector, or may be formed with another layer interposed between. Additionally, another layer such as a protective layer may be formed on the positive electrode active material layer.

The positive electrode active material layer may include the conductive material including carbon nanotubes. Accordingly, it may be possible to notably reduce the electrode resistance, thereby improving the electrode resistance characteristics.

### [Method for Manufacturing Positive Electrode]

The positive electrode having the positive electrode active material layer on the positive electrode current collector may be manufactured by coating the positive electrode active material slurry on the positive electrode current collector, drying, and rolling.

Alternatively, for example, the positive electrode may be manufactured by casting the positive electrode active material slurry on a support, peeling a film from the support, and laminating the film onto the positive electrode current collector. Additionally, any other method may be used to form the positive electrode active material layer on the positive electrode current collector.

### [Lithium Ion Secondary Battery]

According to an aspect of the present disclosure, there is provided a lithium ion secondary battery including the above-described positive electrode. For example, the lithium ion secondary battery includes the above-described positive electrode, a negative electrode, a separator between the positive electrode and the negative electrode, and a nonaqueous electrolyte. Meanwhile, when a solid electrolyte is used as the nonaqueous electrolyte, the separator may be omitted. The lithium ion secondary battery may include a battery case accommodating an electrode assembly including the positive electrode, the negative electrode, and the separator, and optionally a sealing member that seals the battery case.

For example, in the lithium ion secondary battery, when the lithium ion secondary battery is charged and discharged to 4.2V (or 4.25V on the basis of metal lithium) for graphite as a counter electrode for one cycle, electrolyte decomposition does not occur. For example, in the lithium ion secondary battery, when the lithium ion secondary battery is charged and discharged to 4.2V for one cycle, the thickness of the corresponding lithium ion secondary battery remains substantially unchanged except for volume expansion of a negative electrode active material.

### [Negative Electrode]

In the lithium ion secondary battery according to an aspect of the present disclosure, the negative electrode includes a negative electrode current collector and a negative electrode active material layer on one or two surfaces of the negative electrode current collector. The negative electrode active material layer may be formed on all or part of the surface of the negative electrode current collector.

### (Negative Electrode Current Collector)

The negative electrode current collector used in the negative electrode may include those having electrical and chemical stability and conductivity without limitation. For example, the negative electrode current collector may include copper; stainless steel; aluminum; nickel; titanium; sintered carbon; copper or stainless steel treated with carbon, nickel, titanium or silver on the surface; an aluminum-cadmium alloy.

The negative electrode current collector may have a thickness ranging from 3 μm to 500 μm. The negative electrode current collector may have microtexture on the surface to increase the adhesion strength with the negative electrode active material. The negative electrode current collector may come in various forms, for example, film, sheet, foil, net, porous body, foam or nonwoven.

### (Negative Electrode Active Material Layer)

The negative electrode active material layer includes the negative electrode active material, a binder, and a conductive material. The negative electrode active material layer may have a thickness ranging from, for example, 1 nm to 100 μm, 10 nm to 10 μm, or 100 nm to 1 μm. The negative electrode active material layer may be directly formed on the negative electrode current collector, or may be formed with another layer interposed between. Additionally, another layer such as a protective layer may be formed on the negative electrode active material layer.

The negative electrode active material layer may be, for example, formed by coating a negative electrode active material slurry on the negative electrode current collector, the negative electrode active material slurry in which a mixture of the negative electrode active material, the binder, and the conductive material is dissolved or dispersed in a solvent, followed by drying and rolling. The mixture may further include a dispersing agent, fillers, or any other additive, if necessary.

### (Negative Electrode Active Material)

The negative electrode active material may include compounds capable of reversible intercalation and deintercalation of lithium. Examples of the negative electrode active material may include any one of carbon-containing materials such as artificial graphite, natural graphite, graphitizing carbon fibers or amorphous carbon; silicon-containing materials such as silicon powder, amorphous silicon, silicon nanofibers or silicon nanowires; silicon compounds such as silicon alloys, silicon oxide, silicon oxide doped with alkali metal or alkaline earth metal (lithium or magnesium); metallic materials that can form alloys with lithium such as Al, Sn, Pb, Zn, Bi, In, Mg, Ga, Cd, Sn alloys, Al alloys; metal oxide capable of lithium doping and dedoping such as SnO₂, vanadium oxide or lithium vanadium oxide; composites of silicon-containing materials and carbon-containing materials or Sn—C composites, or a mixture thereof, but is not limited thereto. Meanwhile, the carbon-containing material may include any one of low-crystallinity carbon or high-crystallinity carbon. The low-crystallinity carbon may typically include soft carbon and hard carbon, and the high-crystallinity carbon may typically include high temperature sintered carbon such as amorphous, platy, flaky, spherical or fibrous natural graphite or artificial graphite, Kish graphite, pyrolytic carbon, mesophase pitch-based carbon fibers, mesocarbon microbeads, mesophase pitch or petroleum⋅coal-based coke.

The negative electrode active material may be included in an amount ranging from 80 mass % or to 99 mass % based on the total mass of the negative electrode active material layer.

### (Binder and the Conductive Material)

The type and amount of the binder and the conductive material used in the negative electrode active material slurry are the same as the description of the positive electrode.

### (Solvent)

The solvent used in the negative electrode active material slurry may include those commonly used to manufacture the negative electrode without limitation. Examples of the solvent may include any one of N-methyl-2-pyrrolidone (NMP), dimethylsulfoxide (DMSO), isopropyl alcohol, acetone and water or a mixture thereof, but is not limited thereto.

### [Method for Manufacturing Negative Electrode]

A method for manufacturing the negative electrode for the lithium ion secondary battery according to an aspect of the present disclosure may include the steps of dissolving or dispersing the negative electrode active material, and optionally the binder and the conductive material, in the solvent to obtain the negative electrode active material slurry, and in the same way as the method for manufacturing the positive electrode, coating the negative electrode active material slurry on the negative electrode current collector to form the negative electrode active material layer on the negative electrode current collector in order to obtain the negative electrode.

### [Separator]

In the lithium ion secondary battery according to an aspect of the present disclosure, the separator separates the negative electrode from the positive electrode and provides a movement passage of lithium ions, and may include those commonly used as separators in lithium ion secondary batteries without limitation. In particular, separators having low resistance to migration of electrolyte ions and high electrolyte wettability are preferred. For example, the separator may include porous polymer films made from polyolefin-based polymer such as ethylene homopolymer, propylene homopolymer, ethylene/butane copolymer, ethylene/hexane copolymer, ethylene/methacrylate copolymer or a stack structure of two or more layers of them. Additionally, commonly used porous nonwoven fabrics, for example, nonwoven fabrics made of high melting point glass fibers or polyethylene terephthalate fibers may be used. Additionally, to ensure heat resistance or mechanical strength, separators coated with ceramics or polymer materials may be used.

### [Nonaqueous Electrolyte]

In the lithium ion secondary battery according to an aspect of the present disclosure, the nonaqueous electrolyte may include an organic liquid electrolyte or an inorganic liquid electrolyte that may be used to manufacture the lithium ion secondary battery, but is not limited thereto. For example, a solid electrolyte may be also used.

The nonaqueous electrolyte may include an organic solvent and a lithium salt, and optionally, may further include an electrolyte additive. Hereinafter, the liquid electrolyte is referred to as an ‘electrolyte solution’.

The organic solvent may include those that may act as a medium for the movement of ions involved in the electrochemical reaction of the battery without limitation. Examples of the organic solvent may include any one of ester-based solvents such as methyl acetate, ethyl acetate, γ-butyrolactone or ε-caprolactone; ether-based solvents such as dibutyl ether or tetrahydrofuran; ketone-based solvents such as cyclohexanone; aromatic hydrocarbon-based solvents such as benzene or fluorobenzene; carbonate-based solvents such as dimethyl carbonate (DMC), diethyl carbonate (DEC), methyl ethyl carbonate (MEC), ethyl methyl carbonate (EMC), ethylene carbonate (EC) or propylene carbonate (PC); alcohol-based solvents such as ethyl alcohol or isopropyl alcohol; nitrile-based solvents of R—CN (R is C2-C20 straight-chain, branched-chain or cyclic hydrocarbon, and may comprise an exocyclic double bond or ether bond); amide-based solvents such as dimethyl formamide; dioxolane-based solvents such as 1,3-dioxolane; and sulfolane-based solvents or a mixture thereof, but is not limited thereto. In particular, the carbonate-based solvent may be preferred, and more preferably, the cyclic carbonate (for example, ethylene carbonate or propylene carbonate) having high ionic conductivity and high dielectric constant, contributing to the improved charge/discharge performance of the battery may be mixed with the low viscosity straight-chain carbonate-based compound (for example, ethyl methyl carbonate, dimethyl carbonate or diethyl carbonate). In this case, the cyclic carbonate and the straight-chain carbonate may be mixed at a volume ratio ranging from 1:1 to 1:9 to further increase the electrolyte performance.

The lithium salt may include any compound that can provide lithium ions used in the lithium ion secondary battery without limitation. Examples of the lithium salt may include any one of LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiCl, LiI or LiB(C₂O₄)₂ or a mixture thereof, but is not limited thereto. The lithium salt may be, for example, included in the electrolyte at the concentration ranging from 0.1 mol/L to 2 mol/L. When the concentration of the lithium salt is included in the aforementioned range, the electrolyte has the optimum conductivity and viscosity, leading to the outstanding electrolyte performance and effective movement of lithium ions.

The electrolyte additive may be optionally used to improve battery life characteristics, suppress battery capacity reduction and improve battery discharge capacity. Examples of the electrolyte additive may include any one of haloalkylene carbonate-based compounds such as vinylene carbonate (VC), fluoro ethylene carbonate (FEC) or difluoro ethylene carbonate (DFEC), pyridine, triethylphosphite, triethanol amine, cyclic ether, ethylene diamine, n-glyme, hexa phosphoric triamide, nitrobenzene derivatives, sulfur, quinoneimine dyes, N-substituted oxazolidinone, N,N-substituted imidazolidine, ethyleneglycol dialkylether, ammonium salts, pyrrole, 2-methoxy ethanol or aluminum trichloride or a mixture thereof, but is not limited thereto. The electrolyte additive may be, for example, included in an amount ranging from 0.1 mass % to 15 mass % based on the total mass of the electrolyte.

### [Method for Manufacturing Lithium Ion Secondary Battery]

The lithium ion secondary battery according to an aspect of the present disclosure may be manufactured by placing the separator (for example, a separation membrane) and the electrolyte solution between the positive electrode manufactured as described above and the negative electrode manufactured as described above. More specifically, the lithium ion secondary battery may be manufactured by forming the electrode assembly including the positive electrode and the negative electrode and the separator between the positive electrode and the negative electrode, placing the electrode assembly in the battery case, for example, a cylindrical or prismatic battery case and injecting the electrolyte. Alternatively, the lithium ion secondary battery may be manufactured by stacking the electrode assembly, filling it with the electrolyte, placing the obtained resultant product in the battery case and sealing the battery case.

The battery case may include those commonly used in the art. The battery case may have, for example, a cylindrical, prismatic, pouch-like or coin-like shape using a can.

The lithium ion secondary battery according to an aspect of the present disclosure may be used as a power source of small devices as well as a unit battery of a medium- and large-scale battery module including a plurality of battery cells. Preferred examples of the medium- and large-scale device may include electric vehicles, hybrid electric vehicles, plug-in hybrid electric vehicles and energy storage systems, but is not limited thereto.

### EXAMPLE

Hereinafter, the present disclosure will be described by experimental examples. However, the present disclosure is not limited to the following experimental examples.

### Example 1-1

### (Preparation of Positive Electrode Active Material)

Based on 100 parts by mass of LiNi_{0.8}Co_{0.1}Mn_{0.1}O₂ (hereinafter, referred to as ‘lithium transition metal oxide’) powder, 0.1 parts by mass of magnesium fluoride (MgF₂; Stella Chemifa) powder was added and filled in a plastic bottle. The powders were mixed at 700 rpm for about 30 minutes using a rocking mill (Seiwa Giken, RM-01) to obtain a mixture of lithium transition metal oxide and magnesium fluoride as a positive electrode active material. From the observation of the powder particles of the raw materials and the powder particles of the mixture with a scanning electron microscope (SEM), it was confirmed that secondary particle form such as grain size or cracks was common in them.

### (Preparation of Positive Electrode Active Material Slurry)

Subsequently, 96.5 parts by mass of the positive electrode active material, 1.5 parts by mass of carbon black as a conductive material, 2.0 parts by mass of polyvinylidene fluoride (PVDF) as a binder, and N-methyl-2-pyrrolidone (NMP) as a solvent were mixed together to obtain a positive electrode active material slurry.

### (Preparation of Positive Electrode Sheet)

Subsequently, the obtained positive electrode active material slurry was coated on a 20 μm thick aluminum foil to a thickness of about 70 μm, and dried at 130° C. to obtain a positive electrode sheet.

### (Preparation Electrolyte Solution)

Ethylene carbonate, dimethyl carbonate, and diethyl carbonate were mixed at a volume ratio of 1:2:1, 1 mol/L of LiPF₆ was dissolved in the mixture and 2.0 mass % of vinylene carbonate (VC) was added to obtain an electrolyte solution.

### (Manufacture of Coin Cell Battery)

The obtained positive electrode sheet was punched into a circular shape having a diameter of 13 mm to obtain a positive electrode for a coin cell. The obtained positive electrode, a 0.3 mm thick metal lithium negative electrode, and the electrolyte solution were used to manufacture a CR2016 type coin cell battery.

### (Manufacture of Monocell Battery)

Aside from the coin cell, the obtained positive electrode sheet was punched into a rectangular shape having a size of 30 mm×42 mm to obtain a positive electrode for a monocell, a graphite negative electrode of 31 mm×43 mm, and the electrolyte solution were used to manufacture a monocell battery.

### Example 1-2

A monocell battery was manufactured in the same way as Example 1-1, except that a mixture of carbon black and carbon nanotubes (CNT) (1.5 parts by mass) was used as the conductive material rather than carbon black.

### Example 1-3

A coin cell battery was manufactured in the same way as Example 1-1, except that the amount of magnesium fluoride added was 0.25 mass %.

### Example 1-4

A coin cell battery was manufactured in the same way as Example 1-1, except that the amount of magnesium fluoride added was 1.0 mass %.

### Comparative Example 1-1

A coin cell battery and a monocell battery were manufactured in the same way as Example 1-1, except that the process of adding magnesium fluoride was omitted. That is, magnesium fluoride was not added, and LiNi_{0.8}Co_{0.1}Mn_{0.1}O₂ as it stands was used as the positive electrode active material.

### Comparative Example 1-2

A monocell battery was manufactured in the same way as Example 1-2, except that the process of adding magnesium fluoride was omitted.

### Comparative Example 2-1

A monocell battery was manufactured in the same way as Example 1-1, except that lithium transition metal oxide was mixed with magnesium fluoride, after increasing the temperature to 350° C., the obtained mixture was sintered at 350° C. for 5 hours in air, and the temperature was reduced to room temperature. That is, a sintered product obtained by sintering the positive electrode active material of Example 1-1 was used as the positive electrode active material.

### Comparative Example 2-2

A monocell battery was manufactured in the same way as Example 1-2, except that the same sintering process as Comparative Example 2-1 was added.

TABLE 1 summarizes the manufacturing conditions of the Examples and Comparative Examples.

TABLE 1

| | | Magnesium | | Conductive |
|---|---|---|---|---|
| | | fluoride | Sintering | material |
| Example | 1-1 | Added | — | carbon black |
| | 1-2 | Added | — | carbon black + CNT |
| Comparative | 1-1 | — | — | carbon black |
| Example | 1-2 | — | — | carbon black + CNT |
| | 2-1 | Added | 350° C., 5 h | carbon black |
| | 2-2 | Added | 350° C., 5 h | carbon black + CNT |

### Evaluation Example 1: X-Ray Photoelectron Spectroscopy (XPS) Measurement of Positive Electrode Active Material

The positive electrode active materials obtained in Example 1-1, Comparative Example 1-1, and Comparative Example 2-1 were measured using X-ray photoelectron spectroscopy (XPS). The sample to be analyzed is the positive electrode active material in solid state before preparing the positive electrode active material slurry, after sintering. Below are detailed conditions.

### Sample

The positive electrode active material powder fixed to an indium foil was measured. The process from powder sampling to transfer to the machine was performed under an argon atmosphere.

### Measurement Conditions

Machine: Quantera SXM (Ulvac-PHI)
Excitation X-ray: monochromatic Al K1, 2 ray (1486.6 eV)
X-ray penetration: 200 μm
Photoelectron detection angle: 45° (a slope of the detector with respect to the sample surface)

### Data Processing

Smoothing: 9-point smoothing
Horizontal axis correction: C1s main peak (CHx, C—C) at 284.6 eV.

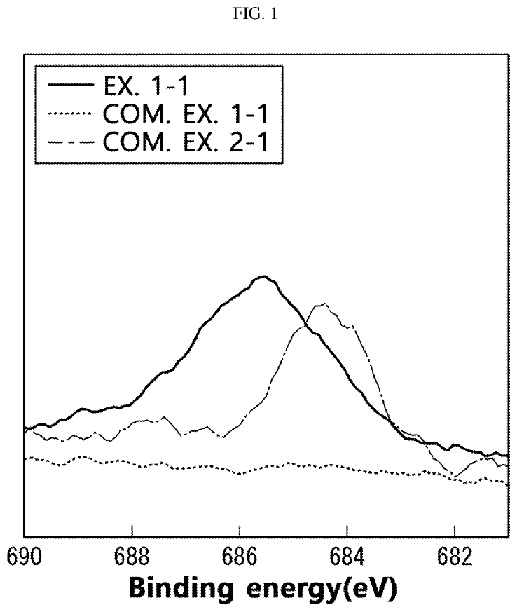

FIG. 1 shows is electron XPS spectra for fluorine of the positive electrode active materials according to Example 1-1, Comparative Example 1-1, and Comparative Example 2-1.

As shown in FIG. 1, in the positive electrode active material of Example 1-1 in which magnesium fluoride was added but sintering was not performed, a 1s electron derived peak of fluorine having the peak top near 685.5 eV in a range between 684 eV and 688 eV was observed. In contrast, in the positive electrode active material of Comparative Example 2-1 in which magnesium fluoride was added and sintering was performed, a 1s electron derived peak of fluorine having the peak top near 684.3 eV in a range between 683 eV and 685 eV was observed. In the positive electrode active material of Comparative Example 1-1 in which magnesium fluoride was not added, a 1s electron derived peak of fluorine was not observed.

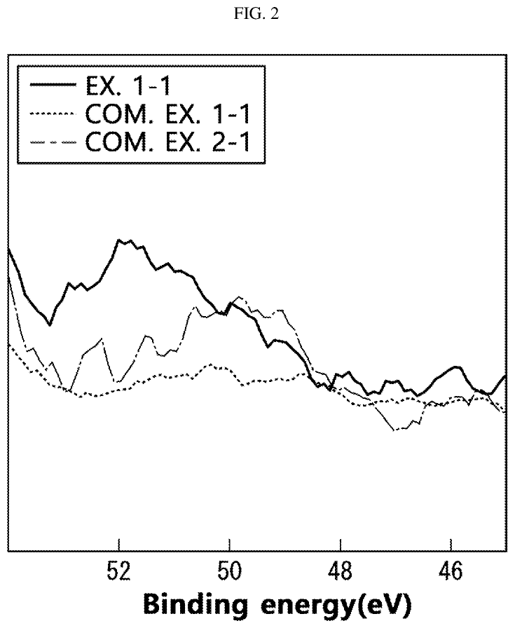

FIG. 2 shows 2p electron XPS spectra for magnesium of the positive electrode active materials according to Example 1-1, Comparative Example 1-1, and Comparative Example 2-1. As shown in FIG. 2, in the positive electrode active material of Example 1-1 in which magnesium fluoride was added but sintering was not performed, a 2p electron derived peak of magnesium having the peak top near 51.0 eV in a range between 50 eV and 52 eV was observed. In contrast, in the positive electrode active material of Comparative Example 2-1 in which magnesium fluoride was added and sintering was performed, a 2p electron derived peak of magnesium having the peak top near 49.3 eV in a range between 48 eV and 50 eV was observed. In the positive electrode active material of Comparative Example 1-1 in which magnesium fluoride was not added, a 2p electron derived peak of magnesium was not observed.

The peak position near 685.5 eV observed in Example 1-1 corresponds to 1s electron peak position of fluorine in the raw material, magnesium fluoride MgF₂. In contrast, the peak position near 684.3 eV observed in Comparative Example 2-1 is close to the is electron peak position of fluorine in the other compound such as sodium fluoride NaF. Likewise, the peak position near 51.0 eV observed in Example 1-1 corresponds to the 2p electron peak position of magnesium in the raw material, magnesium fluoride MgF₂. In contrast, the peak position near 49.3 eV observed in Comparative Example 2-1 is close to the 2p electron peak position of magnesium in the other compound such as magnesium hydroxide Mg(OH)₂. From these results, it is presumed that in Example 1-1 in which the lithium transition metal oxide and the magnesium fluoride were simply mixed, the electron state and chemical state of the raw material, magnesium fluoride, did not change. On the other hand, it is presumed that in Comparative Example 2-1 in which the mixture of lithium transition metal oxide and magnesium fluoride was sintered, the chemical state was changed by the decomposition of the raw material, magnesium fluoride.

### Evaluation Example 2: Capacity Retention of Monocell Battery

For each monocell battery manufactured by each Example and each Comparative Example, at 25° C., ageing was performed at the charge rate of 0.1C and the discharge rate of 0.1C. Subsequently, in a constant temperature tank maintained at 45° C., charging and discharging was repeated at the charge rate of 0.3C and the discharge rate of 0.3C for 300 cycles, within the upper limit of charge voltage of 4.2V and the lower limit of discharge voltage of 2.5V. On the other hand, every 50 cycles, charging and discharge was performed at the charge rate of 0.1C and the discharge rate of 0.1C. From the discharge capacity in each charge/discharge cycle, capacity retention in the n-th charge/discharge cycle defined as the following equation was calculated.

$$Capacity retention ( \% ) = \frac{\begin{matrix}Discharge capacity in n - th charge \\ and discharge cycle\end{matrix}}{\begin{matrix}Discharge capacity in first charge \\ and discharge cyle\end{matrix}} \times 100 \qquad [ Equation 1 ]$$

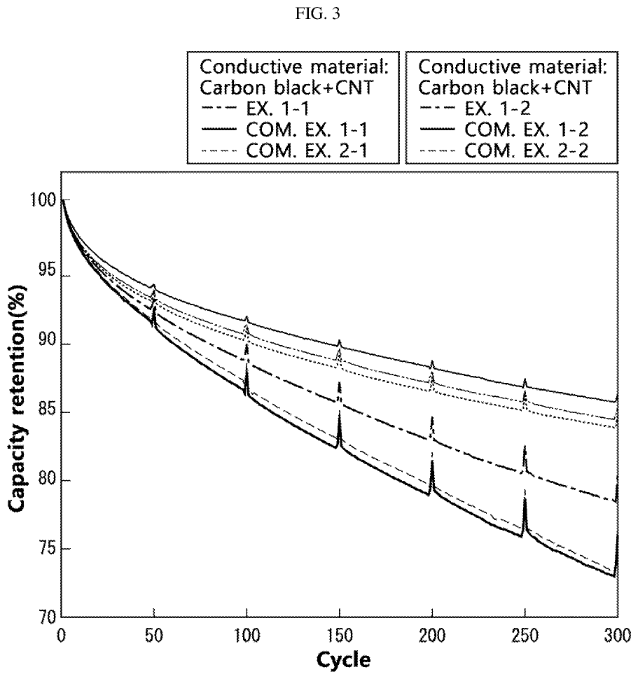

FIG. 3 is a diagram showing a trend of battery capacity change during first to 300th charging and discharging by plotting the above-defined capacity retention as a function of the number of charge/discharge cycles for each monocell battery of each Example and each Comparative Example. For each Example and each Comparative Example, capacity retention in the first cycle was 100%.

As shown in FIG. 3, when comparing Example 1-1, Comparative Example 1-1, and Comparative Example 2-1 using only carbon black as the conductive material, it was confirmed that battery capacity fading in Example 1-1 was significantly suppressed. It was confirmed from the comparison of Example 1-1 with Comparative Example 1-1 that the addition of magnesium fluoride (without sintering) improved the cycling characteristics. From the comparison of Example 1-1 with Comparative Example 2-1, it was confirmed that the non-sintered mixture of lithium transition metal oxide and magnesium fluoride as the positive electrode active material (Example 1-1) had the improved cycling characteristics than the sintered mixture of the lithium transition metal oxide and the magnesium fluoride (Comparative Example 2-1). The cycling characteristics of Comparative Example 2-1 in which sintering was performed were slightly better than Comparative Example 1-1 in which magnesium fluoride was not added.

When comparing the capacity at the charge and discharge current rate of 0.1C every 50 cycles with the capacity at the current rate 0.3C in the common charge and discharge cycles, a capacity difference (i.e., in FIG. 3, the height of spike-shaped peak found every 50 cycles) was smallest in Example 1-1, and largest in Comparative Example 1-1. That is, the positive electrode active material obtained by adding magnesium fluoride and non-sintering was found effective even in high rate cycles, compared to the positive electrode active material in which magnesium fluoride was not added or magnesium fluoride was added and sintering was performed.

It was confirmed that Example 1-2, Comparative Example 1-2, and Comparative Example 2-2 using carbon black and carbon nanotubes (CNT) as the conductive material, had a significant improvement in cycling characteristics, compared to the use of only carbon black as the conductive material. When comparing Example 1-2, Comparative Example 1-2, and Comparative Example 2-2, it was confirmed that in Example 1-2 in which magnesium fluoride was added but sintering was not performed, capacity fading of the battery was significantly suppressed. As shown in FIG. 3, it was confirmed that the addition of magnesium fluoride and non-sintering contributed to the improved cycling characteristics. This is the same tendency as Example 1-1, Comparative Example 1-1, and Comparative Example 2-1. It was confirmed that a difference between capacity during charging and discharging at the current rate of 0.1C and capacity during charging and discharging at the current rate of 0.3C had the same tendency as Example 1-1, Comparative Example 1-1, and Comparative Example 2-1.

### Evaluation Example 3: Change in Direct Current Resistance

For each of Example 1-1, Comparative Example 1-1, and Comparative Example 2-1, in each cycle of the repeated charge/discharge process of Evaluation example 2, direct current resistance (DCR) of the monocell battery was measured. Specifically, direct current resistance was calculated from a slope of a straight line formed by linear approximation of a discharge curve obtained from voltage values at a predetermined interval for 60 seconds immediately from the start of discharge after the battery was fully charged by completing the charging process.

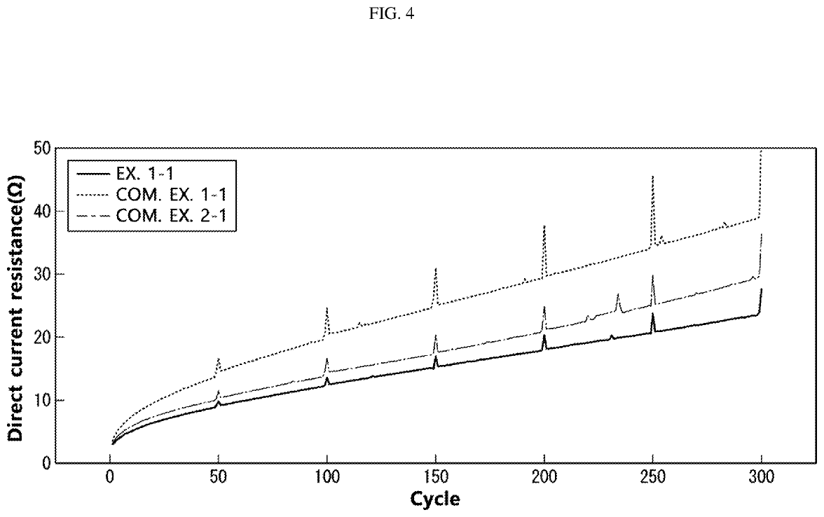

FIG. 4 is a diagram showing a trend of direct current resistance of the battery over the first to 300th charge/discharge cycles, by plotting the direct current resistance in Example 1-1, Comparative Example 1-1, and Comparative Example 2-1 as a function of the number of charge/discharge cycles. As shown in FIG. 4, it was confirmed that in Example 1-1 and Comparative Example 2-1 in which magnesium fluoride was added, the increase in direct current resistance over the repeated charge and discharge was suppressed, compared with Comparative Example 1-1 in which magnesium fluoride was not added. When comparing Example 1-1 with Comparative Example 2-1, it was confirmed that in Example 1-1 in which sintering was not performed, the increase in direct current resistance was suppressed, compared to Comparative Example 2-1.

### Evaluation Example 4: Capacity Retention of Coin Cell Battery

For each coin cell battery manufactured in Example 1-1, Example 1-3, Example 1-4, and Comparative Example 1-1, the trend of capacity retention was investigated in the same way as Evaluation example 2. Specifically, when initial discharge capacity (mAh/g; the mass of magnesium fluoride was ignored when calculating), i.e., discharge capacity in the first charge/discharge cycle is 100%, capacity retention in the 30th charge/discharge cycle and 50th charge/discharge cycle was calculated. In both 30th cycle and 50th cycle, all the capacity retention of Example 1-1, Example 1-3, and Example 1-4 was greater than the capacity retention of Comparative Example 1-1. The following TABLE 2 summarizes differences obtained by subtracting the capacity retention of Comparative Example 1-1 from the capacity retention of each of Example 1-1, Example 1-3, and Example 1-4. As described above, it was confirmed that all Examples, in which magnesium fluoride was added, had higher capacity retention than Comparative Example 1-1 in which magnesium fluoride was not added.

TABLE 2

| | | | Difference in capacity retention | |
|---|---|---|---|---|
| | Magnesium | | compared to Comparative Example 1-1 | |
| | fluoride | | 30th cycle | 50th cycle |
| Example 1-1 | 0.1 | mass % | +0.7% | +2.2% |
| Example 1-3 | 0.25 | mass % | +0.2% | +0.7% |
| Example 1-4 | 1.0 | mass % | +0.6% | +2% |

1. A positive electrode active material, comprising:
a mixture of lithium transition metal oxide particles and magnesium fluoride particles,
wherein a 1s electron spectrum for fluorine observed by X-ray photoelectron spectroscopy analysis has a peak at from 685 eV to 687 eV.

2. The positive electrode active material of claim 1, wherein a thin film of the magnesium fluoride particles is not formed on a surface of the lithium transition metal oxide particles.

3. The positive electrode active material of claim 1, wherein the magnesium fluoride particles are not sintered with the lithium transition metal oxide particles.

4. The positive electrode active material of claim 1, wherein the magnesium fluoride particles are included in an amount ranging from 0.02 parts by mass to 1 part by mass based on 100 parts by mass of the lithium transition metal oxide particles.

5. The positive electrode active material of claim 1, wherein the lithium transition metal oxide particles include nickel.

6. The positive electrode active material of claim 1, wherein the lithium transition metal oxide particles are represented by LiₐNiₓM_{y}O₂, and wherein 0<a≤1.05, x+y=1, 0.4≤x≤1, and M is at least one type of metal other than Ni.

7. The positive electrode active material of claim 1, wherein when comparing a first lithium ion secondary battery to a second lithium ion secondary battery, the first lithium ion secondary battery has a larger value than the second lithium ion secondary battery, wherein the first lithium ion secondary battery is manufactured using a positive electrode including a positive electrode active material layer including 96.5 parts by mass of the positive electrode active material, 1.5 parts by mass of carbon black, and 2 parts by mass of polyvinylidene fluoride on a current collector and a negative electrode including graphite, wherein the second lithium ion secondary battery is manufactured in a same condition as the first lithium ion secondary battery except that a positive electrode active material obtained by sintering the positive electrode active material at 350° C. for 5 hours was used instead of the positive electrode active material, and wherein the value is obtained by dividing a discharge capacity in a 100th charge/discharge cycle by a discharge capacity in a first charge/discharge cycle.

8. A positive electrode active material slurry including the positive electrode active material of claim 1.

9. A positive electrode, comprising:
a current collector, and
a positive electrode active material layer including the positive electrode active material of claim 1 placed on a surface of the current collector.

10. A lithium ion secondary battery comprising the positive electrode of claim 9.

11. A method for preparing a positive electrode active material, comprising:
mixing lithium transition metal oxide particles with magnesium fluoride particles so as to form a mixture,
wherein a 1s electron spectrum for fluorine observed by X-ray photoelectron spectroscopy analysis of the positive electrode active material has a peak at from 685 eV to 687 eV.

12. The method of claim 11, wherein the method does not include sintering the mixture of the lithium transition metal oxide particles and the magnesium fluoride particles.

13. The method of claim 11, wherein the positive electrode active material includes the mixture of the lithium transition metal oxide particles and the magnesium fluoride particles.
